(19) United States
(12) Patent Application Publication
(10) Pub. No.: US 2026/0080049 A1
(43) Pub. Date: Mar. 19, 2026

(54) LIMITING INSTRUCTION EXECUTION

(71) Applicants: Apple Inc., Cupertino, CA (US); Arm Limited, Cambridge (GB)

(72) Inventors: Alexander Donald Charles CHADWICK, Cambridge (GB); Jeff GONION, Campbell, CA (US); Bernard J. SEMERIA, Palo Alto, CA (US); Thomas Philip SPEIER, Wake Forest, NC (US)

(21) Appl. No.: 19/325,358

(22) Filed: Sep. 10, 2025

Related U.S. Application Data
(60) Provisional application No. 63/695,972, filed on Sep. 18, 2024.

(51) Int. Cl. G06F 21/44; G06F 9/46

(52) U.S. Cl. CPC G06F 21/44; G06F 9/468

(57) ABSTRACT

An apparatus is provided that includes an access control register that stores a configuration value and processing circuitry executes instructions. Execution level circuitry applies execution limits of an active execution level for a functionality. Limitation circuitry applies one or more execution limits of a less privileged execution level than the active execution level for the functionality, without affecting the active execution level, in response to the configuration value being a particular value.

This application claims the benefit of priority to U.S. Provisional App. Ser. No. 63/695,972, titled “LIMITING INSTRUCTION EXECUTION,” filed on Sep. 18, 2024, which is incorporated herein by reference in its entirety.

### TECHNICAL FIELD

The present disclosure relates to data processing.

### DESCRIPTION

A data processing apparatus may be able to operate in a number of different execution levels, with each level giving different rights and privileges to the instructions that are executed. The execution level can be changed depending on the nature of the software that is currently executing. Such a configuration provides a measure of security since not every piece of software can perform every operation at any time, allowing more dangerous or security-inhibiting operations to be entrusted only to software that is deemed trustworthy.

### SUMMARY

Viewed from a first example configuration, there is provided an apparatus comprising: an access control register configured to store a configuration value; processing circuitry configured to execute instructions; execution level circuitry configured to apply execution controls of an active execution level for a functionality; and limitation circuitry configured to apply one or more execution controls of a less privileged execution level than the active execution level for the functionality, without affecting the active execution level, in response to the configuration value being a particular value.

Viewed from a second example configuration, there is provided a method comprising: storing a configuration value; executing instructions; applying execution controls of an active execution level for a functionality; and applying one or more execution controls of a less privileged execution level than the active execution level for the functionality, without affecting the active execution level, in response to the configuration value being a particular value.

Viewed from a third example configuration, there is provided a computer program for controlling a host data processing apparatus to provide an instruction execution environment, the computer program comprising: an access control data structure configured to store a configuration value; processing program logic configured to execute instructions; execution level program logic configured to apply execution controls of an active execution level for a functionality; and limitation program logic configured to apply one or more execution controls of a less privileged execution level than the active execution level for the functionality, without affecting the active execution level, in response to the configuration value being a particular value.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus;

FIG. 2 schematically illustrates a data processing apparatus;

FIGS. 3A and 3B schematically illustrate the imposition of access restrictions;

FIGS. 4A and 4B schematically illustrate the imposition of access restrictions;

FIGS. 5A and 5B schematically illustrate the imposition of access restrictions for calls into a shared library;

FIGS. 6A and 6B schematically illustrate the use of a permissions overlay table to control access restrictions dependent on the code seeking access and the target to which access is sought;

FIG. 7 schematically illustrates a two-stage permissions look-up process;

FIGS. 8A and 8B schematically illustrate the use of an instruction region table and a permission overlay table to support a two-stage permissions look-up process;

FIG. 9 schematically illustrates an example permission computation for a load instruction;

FIG. 10 schematically illustrates part of an apparatus comprising a memory management unit that control access permissions;

FIG. 11 schematically illustrates an example permission computation for a branch instruction;

FIG. 12 schematically illustrates an example permission computation for code execution that crosses a page boundary;

FIG. 13 is a flow diagram showing a sequence of steps;

FIG. 14 schematically illustrates a simulator implementation that may be used;

FIG. 15 illustrates an apparatus in accordance with some examples;

FIG. 16 shows a set of registers;

FIG. 17 shows an example of the capabilities that are possible for software running at execution level EL0, software running at execution level EL1, and software running at execution level EL1 when the limitation circuitry is enabled, in accordance with some examples;

FIG. 18 illustrates a flow chart 900 that shows a method of data processing in accordance with some examples;

FIG. 19 schematically illustrates a simulator implementation that may be used;

### DESCRIPTION OF EXAMPLE EMBODIMENTS

Before discussing the embodiments with reference to the accompanying figures, the following description of embodiments is provided.

In accordance with one example configuration there is provided an apparatus comprising: an access control register configured to store a configuration value; processing circuitry configured to execute instructions; execution level circuitry configured to apply execution controls of an active execution level for a functionality; and limitation circuitry configured to apply one or more execution controls of a less privileged execution level than the active execution level for the functionality, without affecting the active execution level, in response to the configuration value being a particular value.

The different execution levels may provide different permissions and rights to functionalities of the processing circuitry. For example, one functionality may be the execution of certain instructions. That functionality might in turn require a particular execution level to operate. Other functionality might involve the ability to access certain registers with some execution levels gaining greater access. The execution level might be changeable in a number of ways and this may be controlled by a mixture of hardware and/or software. In general, a more privileged execution level grants more access to resources and capabilities than a less privileged level. This makes it possible for user-space applications to operate without having access (or perhaps even visibility) to resources that are restricted. However, even with this in place, it may be desirable to control (e.g. limit) the capabilities of software that operates at one of the execution levels. Here, the limitation circuitry is provided so that even though the active (current) execution level is at one particular value, at least some of the controls associated with a different execution level are applied. This control is achieved without needing to create additional execution levels, without having to create additional processes (with inter-process communication) that runs at a less privileged execution level, and without having to create a new set of page tables for those parts of the program that run in the user-space (since each user-space application will have its own view of memory). Note that in some embodiments, the configuration value is a single bit within the access control register with one value of the bit (e.g. 1) being used to cause the controlling of the limitation circuitry and with another value of the bit (e.g. 0) being used to inhibit the controlling of the limitation circuitry. In some examples, the remaining bits of the access control register are used to control other functionality.

In some examples, the limitation circuitry is configured to apply the one or more execution controls of the less privileged execution level for a plurality of functionalities. When the configuration value is the particular value, it may be that a number of different functionalities are affected. For instance, even if the active level is EL1, it may be that the process' ability to both access registers and to execute instructions are treated as if the active level were EL0.

In some examples, the apparatus comprises: a plurality of registers, wherein the functionality comprises accessing the registers; and the execution level circuitry is configured to apply the execution controls of the active execution level for the functionality by controlling the set of the registers that can be accessed by the instructions; and the limitation circuitry is configured to apply the one or more execution controls of the less privileged execution level for the functionality by further controlling the set of registers to which the active execution level can access, without affecting the active execution level. One way in which this control may take place is by controlling (e.g. limiting) some of the registers that can be accessed by the instructions to being less than would normally be accessible to an instruction at the current (active) execution level.

In some examples, the limitation circuitry is configured to apply the one or more execution controls of the less privileged execution level in response to the configuration value being the particular value when the active execution level has a given execution level. Certain execution levels are more widely scoped than others. For instance, a hypervisor level EL2 can be used to control and manage the behaviour of operating systems (typically operating at EL1) and so may typically quite well defined. Hence, the greater control of rights and capabilities can be limited to an execution level where more specific control is appropriate.

In some examples, the given execution level is a kernel execution level. The kernel often has access to privileged capabilities, which may be necessary in order to perform a particular function. However, not all software running at the kernel execution level (also often known as an operating system level of execution, and often referred to as EL1) requires access to restricted resources such as restricted registers. For example, a driver might require access to certain capabilities in order to interact with an external device. However, it may not be necessary for the driver to access certain registers that are reserved for kernel usage and so by setting the configuration value accordingly, it is possible to restrict those drivers from accessing those registers while still being able to communicate with an external device.

In some examples, the limitation circuitry is configured to apply the one or more execution controls of the less privileged execution level by excluding at least some of the registers that require the active execution level to be at least the kernel execution level to access. In these examples, the specific registers for which access is restricted are registers that would ordinarily be accessible to the kernel rather than registers that are accessible in a user-space context for instance.

In some examples, the limitation circuitry is configured to apply the one or more execution controls of the less privileged execution level by excluding only some of the registers that require the active execution level to be at least the kernel execution level to access. In these examples, not all of the kernel level registers are restricted. For instance, in the case of the driver, certain registers that control the functioning of external devices (which may be limited to kernel level) should still be accessible to the driver and so would not be subject to the restrictions.

In some examples, the limitation circuitry is configured to apply the one or more execution controls of the less privileged execution level by setting the set of registers to initially being what is accessible when the active execution level is a user space execution level. A default position in these examples is to change the set of accessible registers to being those registers that can be accessed by instructions that execute in user space (e.g. EL0, or the lowest level of execution possible). In some examples, the process may stop here—in other words, only those registers that can be accessed in the user space level can be accessed by the instruction executing at the kernel level. In other embodiments, this is the starting point and further adjustments are made.

In some examples, the limitation circuitry is configured to additionally allow access to one or more benign registers that are inaccessible when the active execution level is a user space execution level. The use of a particular register may be benign. That is, there is no particular attack vector that can be accessed be using the particular register. In these situations, those registers may still be accessible to an instruction that has had its register access limited as explained above. One example of such a register is a thread identifier register that provides an identifier of a thread that is currently executing.

In some examples, the limitation circuitry is configured to additionally allow read-only access to one or more benign registers that are inaccessible when the active execution level is a user space execution level. In these examples, although access to a benign register may not cause any particular harm, the access that is provided is limited to being read-only access. That is to say that writes to the register may not be permitted. Taking the above example, for instance, the thread identifier register may only be accessible to EL1. That means that instructions that execute at EL0 cannot access the register at all. Instructions that execute at EL2 are permitted to read and write to the register. Meanwhile, instructions that execute at EL1 either have full access to the register or have read-only access to the register depending on the configuration value.

In some examples, the functionality comprises executing the instructions; and the execution level circuitry is configured to apply the execution controls of the active execution level for the functionality by reducing a set of the instructions that are permitted to be executed to only a subset of the instructions that are permitted to be executed by the active execution level. Another functionality that can be controlled is limiting the set of instructions that are permitted to execute. For example, certain instructions could simply be not permitted to execute at all at certain execution levels.

In some examples, the subset of instructions corresponds with instructions that are permitted to be accessed by a user-space execution level. The restriction could therefore be to the set of instructions that are allowed by user-space executed instructions—even though the instructions themselves may be operating in a more privileged execution mode such as in kernel space or even in hypervisor or monitor space.

In some examples, the set of instructions includes and the subset of instructions excludes one or more system management instructions. A system management instruction could be considered to be an instruction that fundamentally alters the behaviour of the overall system rather than a part of it. For instance, such instructions might include supervisor calls or other instructions that can be used to oversee or manage user-space software. Examples include SMC and HVC instructions for example.

In some examples, the apparatus comprises: limitation control circuitry configured to set the configuration value to the particular value and to unset the configuration value from the particular value. The limitation control circuitry is responsible for changing the configuration value so as to cause the further limiting of the instructions (or not) as previously discussed. There are a number of ways in which this setting and unsetting can take place, as will be discussed in the paragraphs below.

In some examples, the limitation control circuitry is configured to set the configuration value to the particular value and to unset the configuration value from the particular value in dependence on a current program counter value. In these examples, the program counter value determines whether the configuration value is set to the particular value or not. In this way, it is possible to cause certain blocks of code (as indicated by the program counter value) to be able to access only a restricted set of registers as compared to the standard access that would be permitted at the usual execution level of those instructions. The particular program counter values can be set as a particular piece of software is loaded. For instance, as the kernel loads a driver, for instance, the kernel might configure the limitation control circuitry so that program counter values representing the driver code execute at a more restricted version of EL1 rather than EL1 itself.

In some examples, the limitation control circuitry is configured to set the configuration value to the particular value and to unset the configuration value from the particular value in dependence on at least part of a current call stack. The call stack represents the series of function calls that are made in code in order to reach a particular part of the code. One reason to consider the current call stack rather than merely the program counter is to allow for the use of libraries. Libraries represent blocks of code that provide functionality that might themselves be used by other blocks of code. Because of this, merely considering the current program counter value of the instruction that is currently being executed may not be sufficient since this might only reveal that code within a library is being executed. In practice, however, one might wish either the library to have higher privileges than the calling code (e.g. as might be given to an instruction executing at the current execution level) or lower level privileges that the calling code (e.g. as might be given an instruction executing at the current execution level). Of course, it is also not as simple as looking at the caller because library code might itself call other library code. Indeed, library code might itself be recursive. It is therefore necessary to consider the call stack in order to determine the point at which library code was entered, for instance.

In some examples, the limitation control circuitry is configured to unset the configuration value from the particular value in response to a return instruction being executed. There are a number of ways in which the configuration value can be unset from the particular value (e.g. to restore the register access back to EL1). As explained above, one way of doing this is based on the call stack and/or the program counter value of the instructions. Another technique that can be used (either instead or as a replacement to the above) is that the configuration value is unset in response to a return instruction (e.g. return from a branch instruction) being executed. In this way, a specific subroutine or specifically isolated block of code can be made to execute under EL1 while seeing a set of registers that are more restricted than those that are visible under EL1.

In some examples, the return instruction is an exception return instruction. This makes it possible to restrict register access to code that, for instance, is triggered by an interrupt or exception handling routine. It is noteworthy that exceptions or interrupts are a common feature of attack vectors because it can sometimes be easy to force an exception or interrupt to occur, and therefore an attacker can force a particular section of code to be executed. By reducing the set of registers that are accessible in this situation (e.g. to less than would be permitted by purely the execution level), exception or interrupt handling routines can be further secured.

In some examples the limitation circuitry configured to apply the one or more execution controls of the less privileged execution level by causing an exception to be taken.

In some examples, data access permissions in relation to a main memory are unaffected by restrictions of the limitation circuitry. In these examples, the limitations that are imposed by the limitation circuitry are not precisely the same as simply changing the execution level to a less privileged level. In particular, the execution and data access permissions (e.g. for memory locations) are still evaluated based on the current execution level. That is, if a page is owned by a particular entity, then the question as to whether the currently executing software is permitted to access that page of memory is at least partly dependent on the current execution level rather than any level that the limitation circuitry may mimic. For instance, if the owning entity is a user-space application under a kernel that is currently executing, then the kernel may be considered to be permitted to access that page of memory—even if the limitation circuitry were to otherwise limit the capabilities of the instructions executed by that kernel.

Particular embodiments will now be described with reference to the figures.

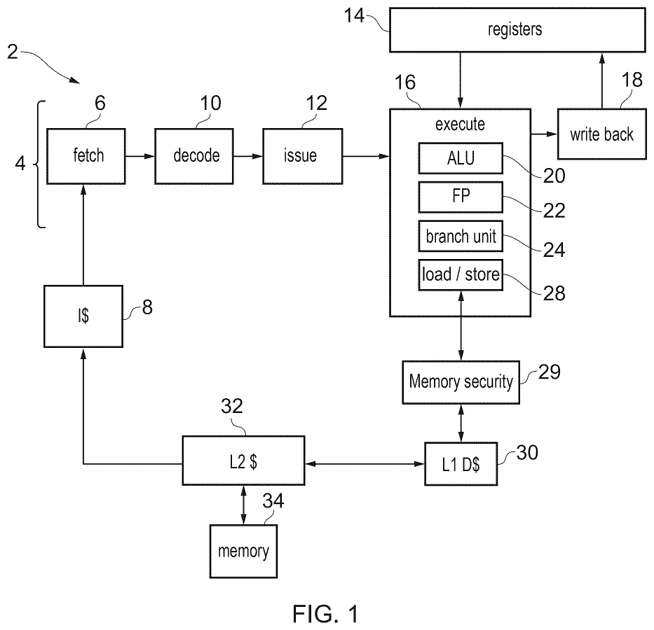

FIG. 1 illustrates a data processing apparatus 2 in accordance with one example embodiment. The apparatus 2 has a processing pipeline 4 that includes a number of pipeline stages. In this example, the pipeline stages include: a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. In the example shown, the execution units include an arithmetic/logic unit (ALU) 20 for performing arithmetic or logical operations; a floating-point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34. In this example, the memory system includes a level one data cache (L1D$) 30, a level one instruction cache (L1I$) 8, a shared level two cache (L2$) 32, and main system memory 34. It will be appreciated that this is just one example of a possible memory hierarchy and other arrangements of caches can be provided. Further shown is a memory security unit 29 that is configured to determine, for memory access requests received from the execute unit 16, whether the requested access to a target memory address of a memory access request is permitted. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or other memory management mechanisms.

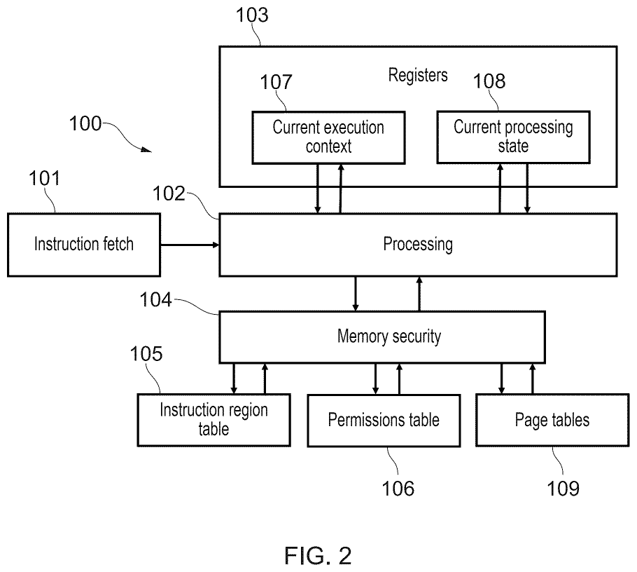

FIG. 2 schematically illustrates in more detail some key components of an apparatus 100 in accordance with the present techniques. The apparatus 100 comprises instruction fetch circuitry 101 that is configured to fetch a sequence of instructions from the memory system for execution by the processing circuitry 102. In a manner with which the person of ordinary skill in the art will be familiar, the sequence of instructions fetched may be dictated by a program counter value corresponding to memory addresses at which those instructions are stored, whereby the program counter value is generally incremented to indicate the next instruction to be fetched and executed, except when it is caused to jump to a different section of program code, for example when a branch is encountered. Some of the instructions executed by the processing circuitry comprise a request specifying a target memory address and the processing circuitry may perform an operation dependent on the target memory address. Whether the processing circuitry is permitted to access the target memory address and thus to perform the operation is controlled by the memory security circuitry 104. Data processing performed by the processing circuitry 102 comprises accessing data values temporarily stored in the registers 103. The registers 103 hold data values with a variety of purposes, for example whilst some register data values, such those in the current processing state register file 108, hold values indicative of a current processing state of the processing circuitry and dictate the current operational configuration of the apparatus, other register data values are obtained by retrieval from the memory system as the subject of the data processing operations that the processing circuitry carries out. When modified by the data processing operations these data values may then be written back to the memory system. The figure further shows the current execution context identifier register 107 that holds a current execution context identifier indicative of a current execution context within a current process that has caused the current instruction to be fetched. The memory security circuitry 104 is further configured to determine, for given memory access request, whether that memory access request is permitted to proceed or not, based both on the target memory address and on the originating particular process and program code, the execution of which has resulted in this memory access request. To do this the memory security circuitry 104 firstly determines with reference to page tables 109, based on the instruction fetch address, a current region identifier. It then performs a lookup in an instruction region table 10, based on the current region identifier and the current execution context identifier provided by the current execution context identifier register 107. This lookup yields a permissions index. The memory security circuitry 104 also determines, based on the target memory address, a target region identifier. It then performs a lookup in a permissions table 106, based on the permissions index and the target region identifier, to yield permissions information for requests issued in response to instructions associated with the current execution context identifier and the current region identifier that specify the target memory address. The permissions information dictate whether the subject request is allowed or prohibited, and consequently the memory security circuitry can then either allow the request to proceed or signal a response to the processing circuitry indicating that the request is prohibited.

The configuration of the memory security circuitry, in particular the memory access control that it provides, based not only on the target memory address to which access is sought, but also on the particular code sequence being executed by the current process that is seeking access to that target memory address, may be beneficial in a number of scenarios. The present techniques recognise that a single application may comprise program code from many disparate origins, such as (common) language runtime, standard libraries, memory allocation functions (malloc), a dynamic linker/loader, shared libraries, application logic and user interface (UI) code. Moreover, amongst runtime-compiled/JIT (just-in-time) code there may be the input code, the JIT compiler, the JIT validator, and the JIT output region. In another example, kernel code may comprise memory management (mm) code, rest-of-kernel code, and kernel-mode drivers. It may be desirable to sandbox these disparate code components from one another, even doing so in both directions. Some examples of the protections that may be desired are that: only malloc code can read/write malloc metadata; only malloc code can write memory tagging extension (MTE) tags; only JIT validator code can write to a JIT output region; WebAssembly (WASM) code regions can only read/write their own heap; shared libraries can only read/write heap (sub)regions of the component that called them; a JIT execution region cannot call an SVC (supervisor call) or sign new pointers using pointer authentication code (PAC). Such sandboxing of defined code components from one another is provided by the present techniques, some use case examples of which are discussed with reference to the next figures.

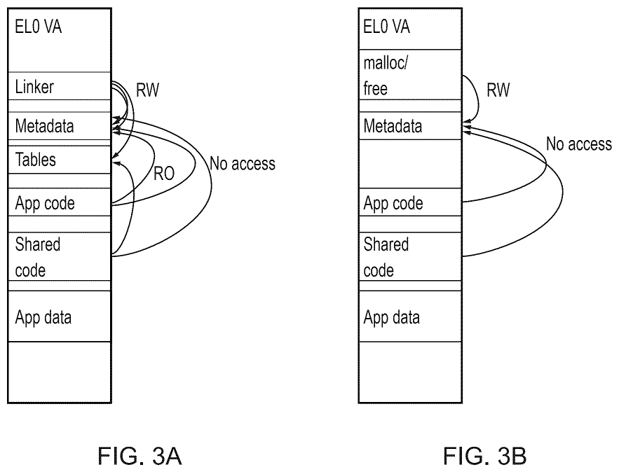

FIG. 3A illustrates an example of further access restrictions being imposed within a given process. In the example shown, code being executed at EL0 (“exception level 0”—the lowest level of privilege in the system) operates within the virtual address (VA) memory space allocated to an application. A dynamic linker is used and the code of that dynamic linker is given read/write access to a region of the VA space for the creation of some tables and associated metadata. The application code is given only read access to those tables and metadata, whilst shared code in this VA space is not permitted to access those tables and metadata at all. FIG. 3B illustrates another example of further access restrictions being imposed within a given process. Here too an application is executing at EL0 within the same VA memory space. Malloc is used and has read/write access to a region of the VA space where metadata is stored. The application code and shared code in this VA space are not permitted to access the metadata at all.

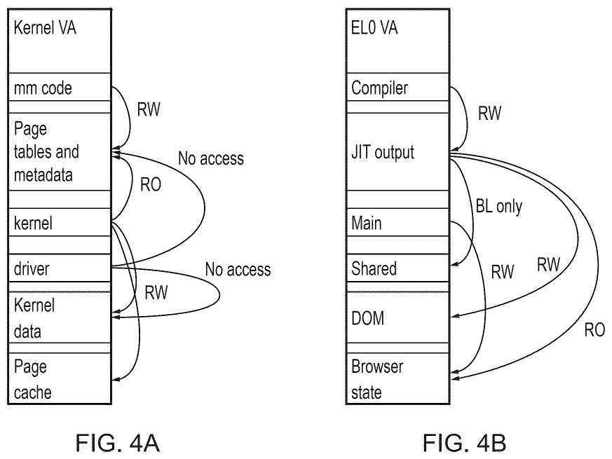

FIG. 4A illustrates an example of further memory access restrictions being imposed within a kernel VA space. In the example shown, memory management (mm) code is used to create/update page tables and associated metadata in a portion of this VA space and thus is permitted read/write access thereto. The kernel code itself is permitted read-only access to the page tables and associated metadata (such that its address translations can be carried out), but is afforded read/write access to portions of the VA space where kernel data and a page cache are stored. This is to be contrasted with a driver used by the kernel, which has no access to the page tables and associated metadata, and has no access to the kernel data. The operations of the memory management function are therefore protected with respect to the kernel and the driver(s), whilst the kernel operations are protected with respect to the driver(s). FIG. 4B illustrates an example of further memory access restrictions being imposed within a VA space used by a dynamic webpage application. A compiler is permitted read/write access to a portion of the address space in which the executable code it generates (the JIT output) is stored. However, that JIT output then has a range of permissions applied, depending on the target memory location. It has branch-only permission to access (and thus jump into) a region of shared code and has read/write access to a portion of the VA space where the document object model (DOM) data are stored. It is however limited to read only access to a portion of the VA space where the browser state is stored.

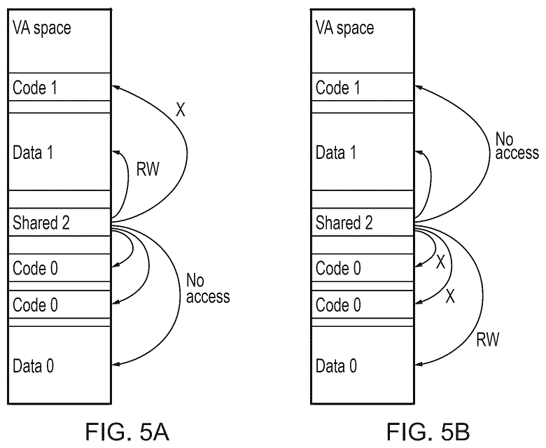

FIGS. 5A and 5B schematically illustrate the imposition of different permissions depending on the caller into a shared library. This is shown in these figures, in which FIG. 5A is an example of a first block of code (“Code 1”) calling a shared library (“Shared 2”), whilst FIG. 5B is an example of a second block of code (“Code 0”) calling the shared library. The purpose here is that, by setting up a different view of permissions according to the caller of the shared library, the library code is only able to manipulate the data of the caller (or even a subset of the data of the caller) and potentially its own private state. Conversely, the caller of the shared library cannot access data that is allocated for other callers of the shared library. Hence, the set up shown in FIG. 5A, in the situation when Code 1 calls the shared library Shared 2, allows Shared 2 read/write access to Code 1's data (“Data 1”). Code 1 itself has execute access to the shared library Shared 2 (such that it can call this library) and the shared library Shared 2 has execute access to Code 1 (such that the program flow can return there following the library call). However, the shared library Shared 2 has no access to Code 0 or its associated data (“Data 0”). This is to be contrasted with the situation in FIG. 5B, which illustrates an example of a second block of code (“Code 0”) calling the shared library Shared 2”. Hence, the set up shown in FIG. 5B allows Shared 2 read/write access to Code 0's data (“Data 0”). Code 0 itself has execute access to the shared library Shared 2 (such that it can call this library) and the shared library Shared 2 has execute access to Code 0 (such that the program flow can return there following the library call). However, the shared library Shared 2 has no access to Code 1 or its associated data Data 1.

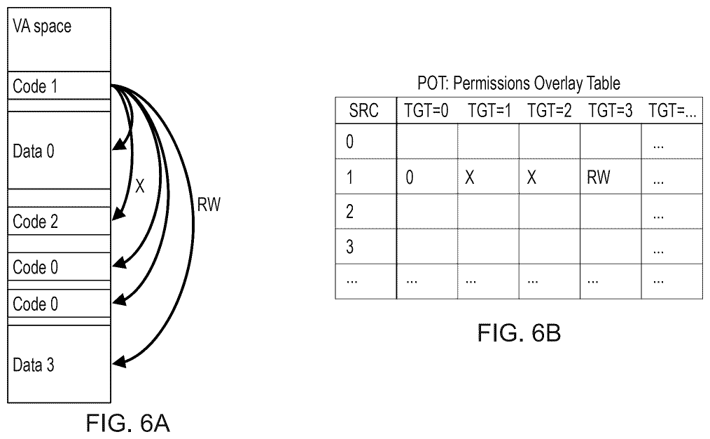

FIGS. 6A and 6B schematically illustrate the use of a permissions overlay table to control access restrictions dependent on the code seeking access and the target to which access is sought in accordance with some examples. These examples correspond to the control of access permissions when Code 1 is being executed. As an initial step in determining the applicable permissions, a base set of permissions, dependent only on the current/source region of code (“SRC”) are established. Here, SRC=1 and thus (accessing the permissions overlay table (“POT”) shown in FIG. 6B, yields the set of permissions {0, X, X, RW, . . . ) (“Permissions”). The target region (“TGT”) (to which a given instruction within Code 1 is seeking access) is then used to select the finer-grained access permission for this combination, i.e. Permissions [TGT]. The example permissions shown for SRC=1 in FIG. 6B are thus: “X” (execute, i.e. branch/jump to) for target regions 1 and 2, and “RW” (read/write) for target region 3. The particular permissions allocated are dictated by the needs of particular instructions, e.g. LDR (load) needs R permission, STR (store) needs W permission, and B/RET (branch/return) needs X permission. FIG. 6A is a graphical equivalent, showing that region Code 1 has RW access to region Data 3 and X access to region Code 2, but has no access to the regions Data 0 or Code 0. Hence, it will be appreciated that the use of the permissions overlay table enables the provision of a distinct “view” of permissions for each region of code.

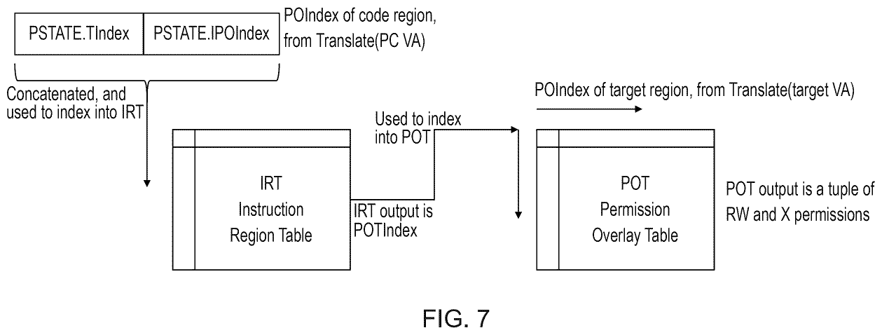

FIG. 7 schematically illustrates a two-stage permissions look-up process in accordance with some examples. In a first stage, information relating to the current process and the particular code being executed is used to determine a first level of the permissions to be allocated. To support this, memory pages are annotated (in their page table entries) with a permission overlay index (POIndex). Also, the processor state (here, PSTATE) held in the registers to define the current processing state is augmented by a temporal index field (TIndex). TIndex is controlled to correspond to the current execution context and, for example, is modified when the exception (privilege) level changes, such as on exception entry to a more privileged exception level or on legal exception return to a less privileged exception level. Thus TIndex provides an element of the current context and as such is not a process identifier (e.g. an ASID), but rather a particular current execution context (of which there may therefore be several for a given process). ritten into PSTATE.IPOIndex. This value is concatenated with PSTATE.TIOn exception entry/return without a change in exception level, TIndex is unchanged. The permission overlay index forms part of the translation information accessed when a virtual address is translated into a physical address. At the first stage then, two identifiers PSTATE.TIndex and PSTATE.IPOIndex are derived. PSTATE.TIndex identifies what process is currently executing and PSTATE.IPOIndex (obtained by translating the program counter virtual address) identifies the particular code being executed. PSTATE.TIndex and PSTATE.IPOIndex are concatenated and used to index into an instruction region table (IRT). The IRT of this example is a one-dimensional table, with each entry comprising a permissions index (POTIndex). Note that there are distinct instruction region tables for each exception level. Next, in the second stage of the two-stage permissions look-up process, the POTIndex is used as a first index into a two-dimensional permission overlay table (POT). The second index then used to identify a particular entry in the POT is the POIndex of the target region of code or data, which is obtained by translating the target region virtual address. The identified POT entry thus forms the output of the two-stage permissions look-up process and in this example in the form of a tuple of R, W, and X permissions.

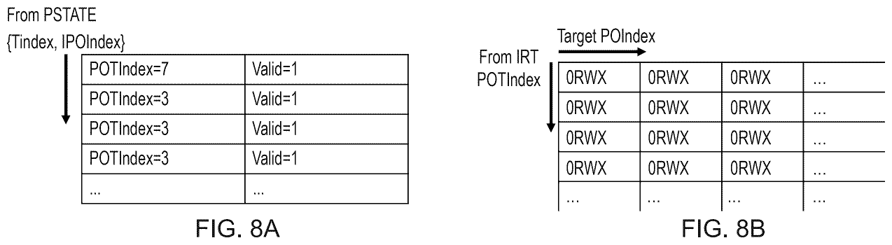

FIGS. 8A and 8B schematically illustrate the use of the above-mentioned instruction region table and permission overlay table to support a two-stage permissions look-up process in accordance with some examples. Being used in association with the address translation mechanisms, these are stored in the output address (OA) space (in a similar manner to translation tables). The one-dimensional instruction region table is indexed into by the PSTATE.TIndex+PSTATE.IPOIndex concatenation giving the POTIndex value. A valid bit also controls the validity of the entries. In one specific example embodiment, the table has 16-bit entries stored in 2¹⁴ rows thus occupying 32 KB of storage space. The two-dimensional permissions overlay table is indexed into by the POTIndex output by the instruction region table and by the target code POIndex. In one specific example embodiment, the table has 128 rows and 128 columns of 4-bit entries, each giving the R, W, X overlay permissions, thus occupying 8 KB of storage space. Further, in a variant of the embodiment shown in FIGS. 8A and 8B, an additional execution permission (“X bit”) can be added to the instruction region table (FIG. 8A) and the execute permission (“X”) is not provided as one of the overlay permissions given by the permission overlay table (FIG. 8B). In such as case, the instruction region table is still indexed by TIndex and POIndex from the translation of the PC VA. As such, the X bit in each IRT entry therefore indicates whether the specified TIndex is permitted to execute the specified POIndex. Thus a further execute permission (X bit) control is provided.

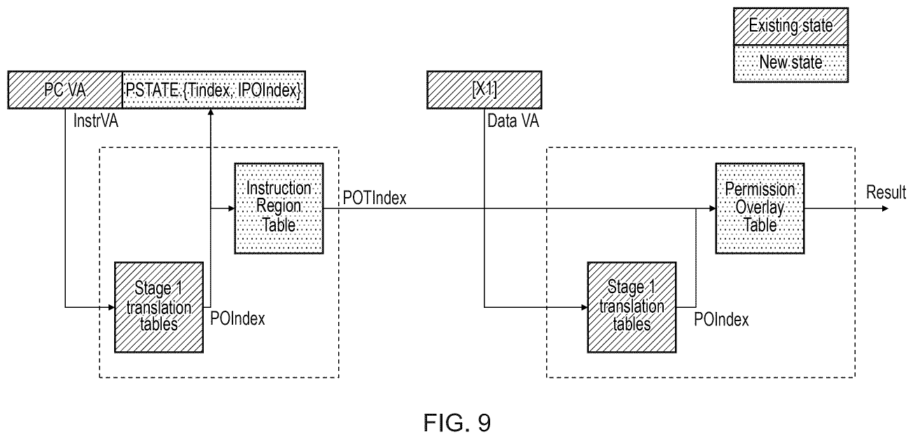

FIG. 9 schematically illustrates an example permission computation for a load instruction, e.g. LDR X0, [X1], in accordance with some examples. The VA of the source instruction (LDR) (i.e. the program counter (PC) VA) is fed into the stage 1 translation tables to give a POIndex. If the (partial) execution of the instruction does not generate an instruction abort, then the (source) POIndex from the translation of the PC VA is written into PSTATE.IPOIndex. This value is concatenated with PSTATE.TIndex (the current execution context), and the concatenation of the two indexes into the instruction region table. The instruction region table output is a POTIndex. The load instruction's target VA (i.e. the address from which the load sohoudl retrieve a data value) is fed into the stage 1 translation tables to give a (target) POIndex and this POIndex and the POTIndex are the indexes for the permissions overlay table, resulting in a set of overlay permissions. This output can be cached as (part of) a TLB entry as is described in more detail below.

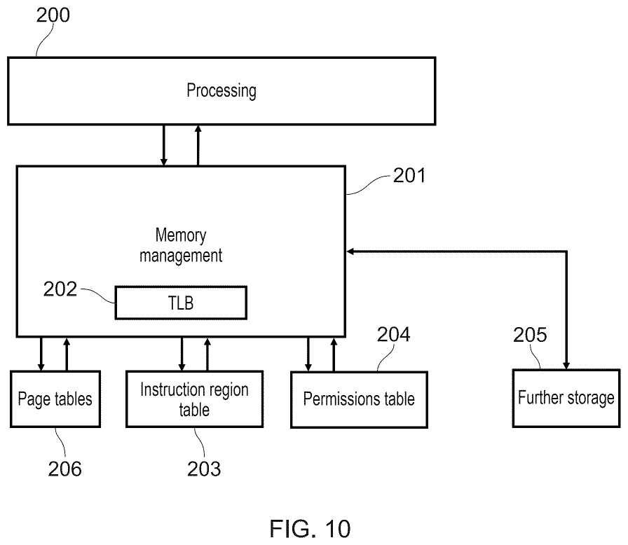

FIG. 10 schematically illustrates part of an apparatus comprising a memory management unit that controls access permissions in accordance with some examples. Access to memory initiated by instructions executed by the processing circuitry 200 are handled by the memory management unit (MMU) 201. The MMU 201 controls the process which translates virtual addresses (VA) used by the processing circuitry 200 into physical addresses used in the memory system being accessed. Page tables 206 stored in memory define the translations and further provide some access permissions associated with the regions of memory being accessed. Address translation information retrieved from the page tables is cached in the translation lookaside buffer (TLB) 202 in order to avoid the latency associated with a full page table walk (which is necessary the first time that a given translation is required) for repeatedly accessed memory locations. The MMU 201 also accesses an instruction region table 203 and a permissions table 204 in order to implement the present techniques, as described in more detail elsewhere herein. The output of the access to the permissions table, the permissions overlay information, is combined with the page table derived access permissions in order to derive the final access permissions that are imposed. This combination can be additive, i.e. that any action permitted by either the page table derived access permissions or the permissions overlay information is allowed. Alternatively, the combination can be subtractive, i.e. that for an action to be allowed it must be permitted by both the page table derived access permissions and the permissions overlay information. The latter approach is proposed in the example shown in FIG. 10. The outputs of the tables accessed and/or the final access permissions derived can also be cached. In one configuration of the arrangement shown in FIG. 10, entries in the TLB 202 are used to hold the permission overlay index (POIndex) value retrieved from the memory page tables. In this case, when an access needs to be checked, the MMU 201 has to re-fetch the permissions tables from memory, or may be provided with a separate storage structure 205 in which they are held. This further storage 205 can be provided as a caching structure (like a TLB), indexed by the appropriate POIndex values. In another configuration of the arrangement shown in FIG. 10, when the MMU 201 computes the final permissions according to the POIndex+permissions tables, these final permissions can then be combined with the corresponding TLB entry to and stored in the TLB 202.

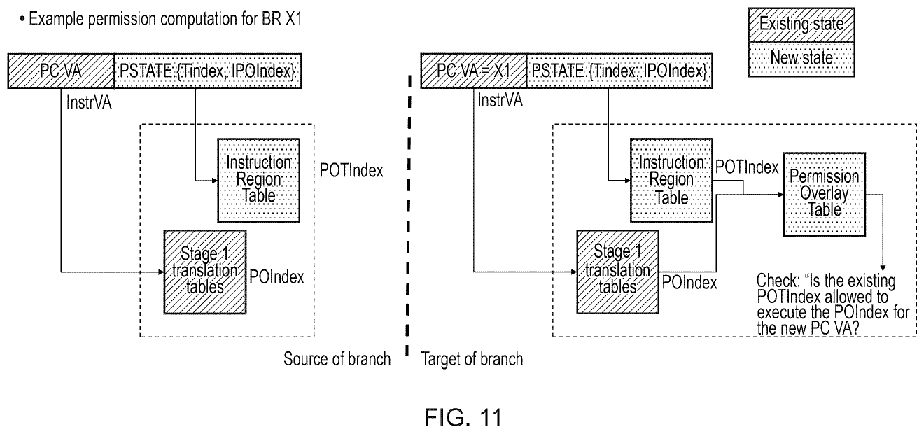

FIG. 11 schematically illustrates an example permission computation for a branch instruction in accordance with some examples. The target address to which the branch should jump in this example is X1. Note that the left hand side of the figure schematically illustrates aspects of the permission computation relating to the source of the branch, whilst the right hand side of the figure schematically illustrates aspects of the permission computation relating to the target of the branch. The VA of the source of the branch (i.e. the current program counter (PC) VA) is fed into the stage 1 translation tables to give a POIndex. The branch instruction's POIndex from the translation of the PC VA is written into PSTATE.IPOIndex. This value is concatenated with PSTATE.TIndex (an element of the current execution context), and the concatenation of the two indexes into the instruction region table. The instruction region table output is a POTIndex. The target of the branch, i.e. the target instruction VA, is fed into the stage 1 translation tables to give a (target) POIndex and this POIndex and the POTIndex are the indexes for the permissions overlay table, resulting in a set of overlay permissions. The combined final permissions are used to determine whether this branch is permitted, i.e. whether the current POTIndex (for the source of the branch) allowed to execute the POIndex for the new PC VA (i.e. the target instruction of the branch. If it is, the branch proceeds. If it is not, this is signalled to the processing circuitry.

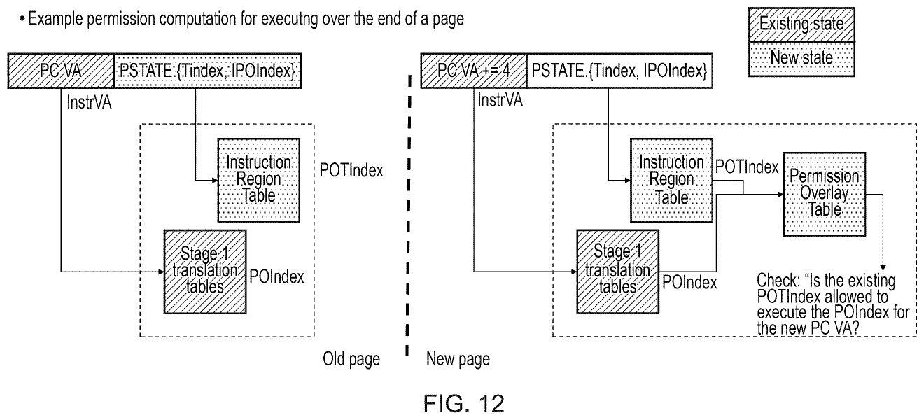

FIG. 12 schematically illustrates an example permission computation for code execution that crosses a page boundary in accordance with some examples. This is similar to the example of FIG. 11, except that the “source” here is the old page and the “target” is the new page. The left hand side of the figure schematically illustrates aspects of the permission computation relating to the old page, whilst the right hand side of the figure schematically illustrates aspects of the permission computation relating to the new page. The VA of the last instruction of the old page (i.e. the current program counter (PC) VA) is fed into the stage 1 translation tables to give a POIndex. The instruction's POIndex from the translation of the PC VA is written into PSTATE.IPOIndex. This value is concatenated with PSTATE.TIndex (an element of the current execution context), and the concatenation of the two indexes into the instruction region table. The instruction region table output is a POTIndex. The first address of the new page, determined as PC VA+4, is fed into the stage 1 translation tables to give a POIndex for the first address of the new page and this POIndex and the POTIndex are the indexes for the permissions overlay table, resulting in a set of overlay permissions. The combined final permissions are used to determine whether execution may indeed continue over the end of the old page onto the new page. When it is, sequential instruction execution continues. When it is not, this is signalled to the processing circuitry.

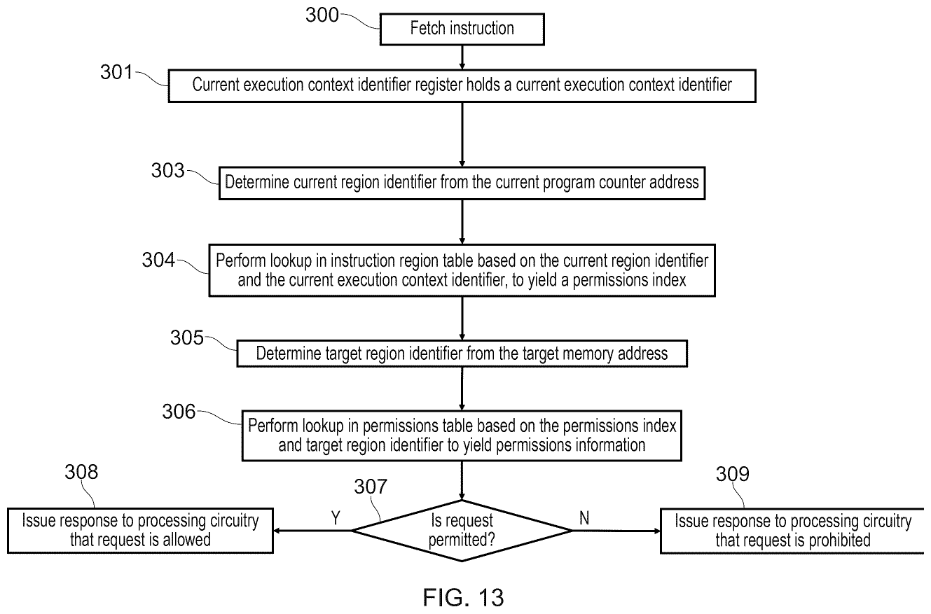

FIG. 13 is a flow diagram showing a sequence of steps which are taken in accordance with the method of some examples. The sequence shown begins at step 300 where an instruction is fetched and step 301 shows the current execution context identifier register holding a current execution context identifier. At step 303 a current region identifier is determined from the current program counter value. Then at step 304 a look up is performed in an instruction region table based on the current region identifier and the current execution context identifier to yield a permissions index. Next at step 305 a target region identifier is determined from the target memory address. Then at step 306 a look up in a permissions table is performed based on the permissions index and the target region identifier to yield permissions information. It is then determined at step 307 whether the request is permitted to proceed. If it is not then the flow is proceeds to step 309 at which a response is issued (e.g. by the memory security circuitry) to the processing circuitry indicating that the request is prohibited. When the request is permitted the flow proceeds to step 308, issuing a response to the processing circuitry that the request is allowed. Note that an explicit “allowed” notification at step 308 may be omitted, and the re request is simply allowed to proceed.

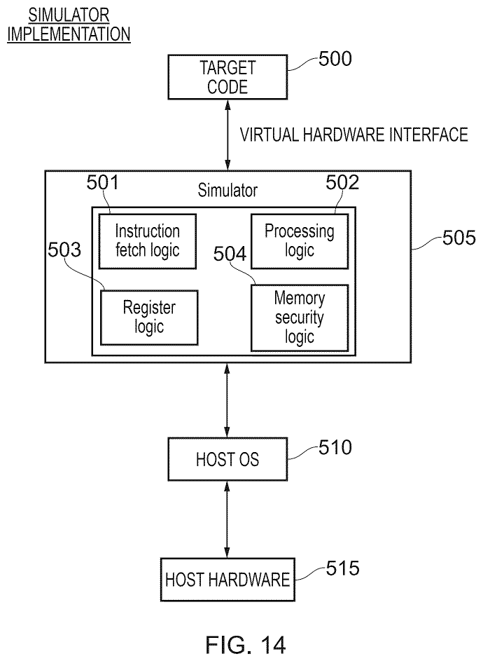

FIG. 14 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 515, optionally running a host operating system 510, supporting the simulator program 505. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 515), some simulated embodiments may make use of the host hardware, where suitable.

The simulator program 505 may be stored on a computer-readable storage medium (which may be a non-transitory medium), and provides a program interface (instruction execution environment) to the target code 500 (which may include applications, operating systems and a hypervisor) which is the same as the interface of the hardware architecture being modelled by the simulator program 505. Thus, the program instructions of the target code 500 may be executed from within the instruction execution environment using the simulator program 505, so that a host computer 515 which does not actually have the hardware features of the apparatuses discussed above can emulate these features, these being provided by instruction fetch logic 501, processing logic 502, register logic 503, and memory security logic 504.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

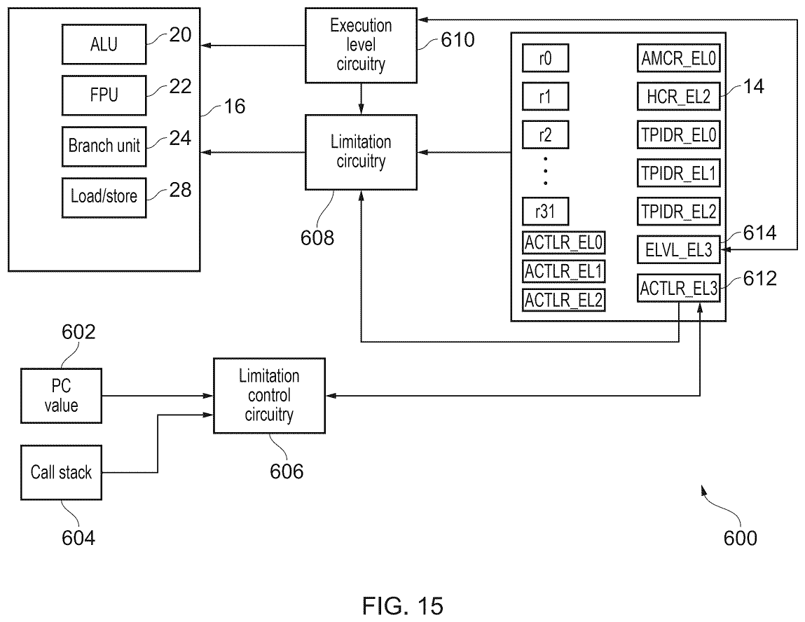

FIG. 15 illustrates an apparatus in accordance with some examples. The apparatus includes execution level circuitry 610 that controls an execution level of the data processing apparatus. In particular, in response to different execution levels, the capabilities of the data processing apparatus 600 can be changed. At a lowest execution level EL0, user-space applications are permitted to run and are given the appropriate capabilities to operate. At a next highest execution level EL1, a kernel is able to operate. In this more privileged execution level, it may be possible to access resources that are prohibited to the user-space applications. For instance, the kernel level EL1 may be able to access control registers that control a frequency of the scheduler that indicates which application is next to execute. The kernel level EL1 may also be able to allocate memory to user-space applications. Furthermore, while each user-space application may only be able to see and access memory that has been allocated to it, software running in the kernel level EL1 may be able to see and access memory belonging to any user-space application running under that kernel, or indeed to see and access memory allocated specifically to the kernel. A further execution level EL2 could be provided that allows multiple kernels or operating systems to execute. The software executing at EL2 may be able to access memory that is allocated to any kernels or operating systems that execute under that hypervisor and may have access to instructions or operations, or registers that control how the operating systems work. For instance, the hypervisor might have access to a register that controls the permissions of an operating system, the capabilities of an operating system, how time is divided among the operating systems, and so on. A still further level EL3 can be provided that allows multiple hypervisors to operate and a top level (which could also be EL3) can be provide to change overall modes of operation of the data processing apparatus such as whether the device is operating in a secure domain or a non-secure domain—with each of the domains being isolated from each other and with each domain potentially demanding the use of particular hardware over other hardware such as tamper proof memory. Of course, it will be appreciated that this is merely one example of a number of execution levels and that other configurations are possible without deviating from the concept of the present disclosure.

In any event, each execution level (of which there are a plurality) defines particular rights, capabilities and permissions that are available to software executing at that level and this is enforced by the execution level circuitry 610 with reference to the current execution level, which is stored in a register ELVL_EL3. Here, the suffix _EL3 indicates that the register is owned and can only be written to by software running at the execution level EL3.

Also in this example is limitation circuitry 608. The limitation circuitry 608 is used to change the permissions and capabilities that are available to a given execution level without changing the execution level that is operating. In this way, it is possible to provide a further restriction to certain software while still maintaining other rights owned by software at that level. One situation in which this might arise is with a driver, for instance. A driver forms part of the kernel and consequently will require at least some capabilities that are reserved for EL1. However, the ability to access particular registers reserved for the kernel (for instance, a frequency with which the scheduler runs) is not required for a driver and so such capabilities can be removed by the limitation circuitry 608. In other respects, however, the permissions of the driver remain at EL1. For instance, the driver's ability to access memory may remain that of EL1. A register ACTLR_EL3 612 is provided that provides an indication of whether the limitation circuitry 608 is in operation. In some configurations, the configuration value stored in the register ACTLR_EL3 612 makes it possible to control the extent to which the limitation circuitry 608 operates. Note that again, the register is owned by software running at execution level EL3 and so if this particular value is enabled, software running at EL1 (for instance) cannot disable this capability in order to obtain increased permission.

Limitation control circuitry 606 is also provided in order to control the value stored in the register 612. In this example, the limitation control circuitry 606 modifies the value stored in the register 612 so as to enable the limitation mode of the limitation circuitry 608 based on a value of a program counter 602 and a call stack 604. In this way, it is possible for particular parts of a program to have limitations activated or deactivated. For instance, taking the previous example of the driver, the limitation control circuitry 606 could be configured so that for values of the program counter 602 that represent the kernel, the limitation mode is activated. Meanwhile, for another driver, or for the scheduler portion of the kernel that falls outside the specified range of program code in which the driver operates, the limitation mode is not enabled and so the software operates with the typical rights and permissions according by the execution level circuitry 610.

A further factor that can be considered is that of the call stack 604. In these examples, the call stack can be analysed to determine a caller of the instructions that are currently executed. This can be relevant in the situation regarding library code, for instance, where it may be more relevant as to which code called a library function. Again considering the driver, it may not be appropriate for the driver to evade its permissions limitation by making a library call. Hence by examining the call stack 604, it is possible to determine that a particular library was called by the driver and so even though the library itself is not part of code for which the limitation would be in place, the limitation remains because the caller was code for which the limitation exists. Of course, it may not always be appropriate for the call stack to be used in this way. In some situations, it may be desirable for the library to operate without the limitation—particularly if the library is trusted code for instance.

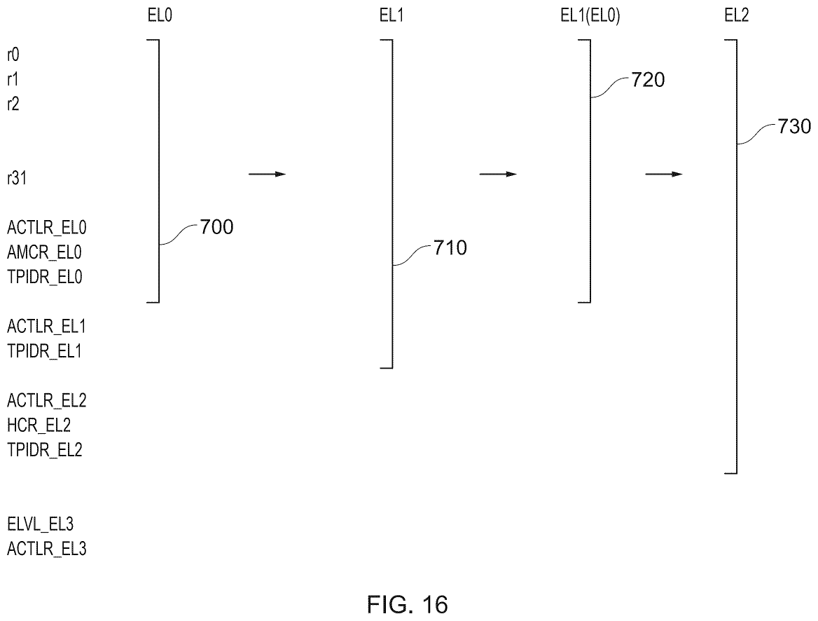

As previously mentioned, there are a number of ways in which the rights and capabilities can be adjusted. In some examples, the set of registers that can be accessed by the software is altered. FIG. 16 shows a set of registers. These include general purpose registers r0 to r31 that are used for performing general purpose computations. Further special purpose registers are then provided. As before, the suffix can indicate the execution level that owns the particular register with software executing at that level (or at a more privileged level) generally being able to fully access the register. In some situations, the register might also be available to read (only) by software operating at a less privileged execution level. Note that also in some cases, there are several versions of a register available—e.g. to multiple different execution levels. However, this is not always the case.

In a first example, software operates at an execution level EL0. This could, for instance, correspond with user-space software such as a game or business utility such as a word processor. Such software typically does not require any special permissions or ability to change the overall operation of the computer. Here, the software is granted access to a particular range of registers 700 that includes the general purpose registers r0 to r31 as well as ACTLR_EL0, AMCR_EL0, TPIDR_EL0. The exact purpose of this special registers is irrelevant and the only significance is that they are generally deemed to be accessible to any software executing under EL0. They might, for instance, indicate the current time, indicate the ID of a thread or process that is currently executing and so on.

In a second example, software operates at an execution level EL1. Here, the limitation circuitry 608 is disabled. The range of registers 710 is expanded beyond those that are accessible at execution level EL0. In particular, all of the registers that can be accessed by software executing at EL0 is also available to software executing at EL1. In addition, such software has access to the registers ACTLR_EL1 and TPIDR_EL1.

Note that so far, none of the software has access to registers with a suffix of _EL2 or _EL3. For instance, the register ELVL_EL3 or the register ACTLR_EL2 cannot be accessed by any of the mentioned software, which operates at EL0 or EL1.

In a third example, software operates again at an execution level EL1. However, this time the limitation circuitry 608 is enabled and so the range of registers 720 that can be accessed is limited. Specifically, the set of registers is limited to being the same as those registers 700 that are accessed at EL0. Nevertheless, the software itself continues to operate at EL1. It may, for instance, still be able to access memory that is reserved for software running at EL0 (provided that software runs under the software running at EL1).

Finally, in a fourth example, software operates at execution level EL2 and it is assumed that the limitation circuitry 608 is disabled. Here, the range of registers 730 is expanded once again to incorporate ACTLR_EL2, HCR_EL2, and TPIDR_EL2. However, the range 730 still does not encompass registers reserved for execution level EL3 such as ELVL_EL3 and ACTRL_EL3.

Note that in this example, the limitation circuitry 608 is disabled when the execution level is at EL2. In some examples, if the limitation circuitry 608 were enabled (e.g. via the E0 flag previously described) then this would cause the instructions executing at EL2 to again be limited to access the set of registers 700 reserved for EL0. In other embodiments, the limitation provided by the limitation circuitry 608 is reserved for a single execution level such as EL1 and has no effect on other execution levels.

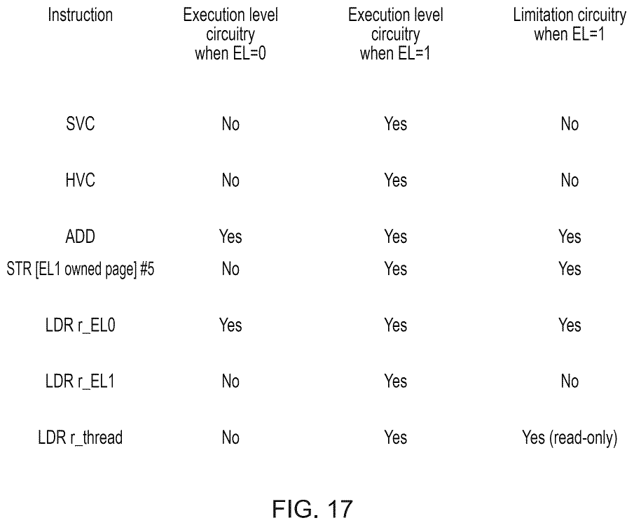

The restriction capabilities are not limited to restricting ranges of registers but can also cover the type of instruction that can be executed. FIG. 17 shows an example of the capabilities that are possible for software running at execution level EL0, software running at execution level EL1, and software running at execution level EL1 when the limitation circuitry is enabled.

In this example, the instruction SVC (supervisor call) is prohibited to software running at EL0. The SVC instruction is a special instruction that is typically reserved by the kernel and makes it possible to issue exceptions or interrupts as well as make other special requests to hardware that are usually reserved for the kernel/operating system. It is thus appropriate that the execution level circuitry 610 prohibits access to such an instruction to software running at EL0. In contrast, software running at EL1 (when the limitation circuitry 608 is disabled) is permitted to execute the instruction. Meanwhile, software that runs at EL1 that has been limited by the limitation circuitry 608 is not permitted to execute this instruction. There are a number of ways in which this prevention can be achieved. The exact method is irrelevant to the present disclosure, but this can be handled by the hardware causing an exception to be raised when the appropriate execution unit 16 tries to execute it in the wrong mode (or when prohibited by the limitation circuitry 608).

Another example is the instruction HVC, which refers to a hypervisor call exception. This can be used to activate the hypervisor, to cause the hypervisor to perform some particular action (e.g. allocating more memory to a particular kernel, requesting access to shared hardware and so on). Again, it may be inappropriate for mere user-space software to execute such an instruction—at least directly. Consequently, this is prohibited by the execution level circuitry 610. While it may be permitted to kernel software running at EL1, this relies on the limitation circuitry 608 not being active, which prevents the HVC instruction from being executed even by software that runs at execution level EL1.

Another example is an ADD instruction. Typically such an instruction may be considered to be sufficiently benign (and potentially even essential) that it is permitted to be executed by software running at execution level EL0 and level EL1 and the limitation circuitry 608 does not affect the execution of such an instruction, even if active.

Another example is a store instruction to memory owned by software running at EL1. In this example, the execution level circuitry 610 (or indeed, memory protection circuitry) prevents access to memory to software running at EL0 as not having sufficient permission. On the other hand, software running at EL1 that happens to own the page is permitted to access that page. In this case, even if the limitation circuitry 608 is running, the limitation circuitry does not affect this element of the permissions check. In other words, even though software running at execution level EL0 is not permitted to access the page, software running at execution level EL1 still runs at EL1—even if it is limited by the limitation circuitry 608. Consequently, the ability to access this memory remains the same. Thus, while some capabilities are reduced, not all capabilities are reduced to that of EL0.

The next example relates to a situation in which a load is performed using a register that is reserved for execution level EL0. Here, the operation can be performed by software running at EL0, software running at EL1, and software running at EL1 that has been limited.

The next example relates to accessing a register that is owned by execution level EL1. Here, instructions executing at EL0 are not permitted to access the register. Instructions executing at EL1 are permitted to access the register unless they are limited by the limitation circuitry 608.

The final example shows another variant. This example regards a particular register r_thread that provides an identifier of a thread that is currently executing. Here, the register cannot be accessed by software running an execution level EL0. However, it can be accessed by software running at execution level EL1. In this example, however, the register can be considered to be sufficiently benign that although the limitation circuitry 608 typically reduces the register access to that of EL0 (while keeping the actual level at EL0), the limitation circuitry does not completely limit access to the register when it is operating. In some examples, full access to the register may be provided. However in this example a middle ground is followed in which the limitation circuitry 608 does not provide full access to the register but instead only provides read-only access to the register.

Thus, the register access that is provided to software that is affected by the limitation circuitry 608 corresponds with access that is not defined by one of the execution levels, but instead lies between two of the execution levels. Furthermore, such access takes place without the actual execution level changing and so things such as memory accesses remain the same. For instance, the limitation circuitry 608 has no affect on the POTIndex as previously described.

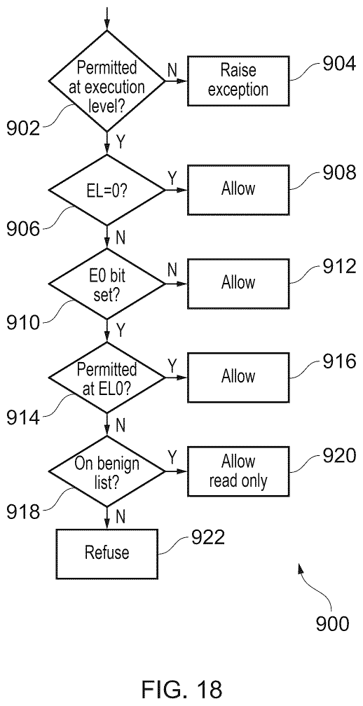

FIG. 18 illustrates a flow chart 900 that shows a method of data processing in accordance with some examples. The process begins at a step 902 where it is determined whether the instruction or operation to be performed is permitted at the current execution level. If not, then an exception is raised at step 904. Otherwise, the current execution level's permissions allows the operation to proceed but something else might prevent it from taking place. The flow then continues to step 906, where it is determined whether the current execution level is EL0 (i.e. the lowest execution level). If so, then at step 908 the operation or instruction is permitted. In this example, it is anticipated that it is not possible to have fewer permissions to those granted at EL0 and consequently if the current execution level is EL0 then the operation is permitted. Otherwise the flow proceeds to step 910 where it is determined whether the EL0 bit is set or not, i.e. whether a more restrictive mode of operation is executing. If not, then because the operation is permitted by the current execution level (determined at step 902), the operation is permitted at step 916. Otherwise, at step 914 it is determined whether the operation would be permitted at execution level EL0. If so, then as per previous assumptions, the operation is always allowed and so at step 916, it is permitted. The flow then proceeds to step 918. At this stage, it has been established that we are applying restrictions beyond the current execution level, that the operation would normally be allowed but is not allowed all of the time and is not permitted at execution level EL0. At step 918, it is determined whether the instruction or operation is on a ‘benign’ list of instructions and operations. This is a list of instructions or operations that are only permitted at more privileged execution levels than the least privileged level, but nevertheless are sufficiently benign that even when we want to lower the effective execution level (e.g. to EL0), they are permitted. If not, the operation is refused at step 922. Otherwise, the operation is permitted at step 920 but is only permitted as part of a read-only operation. That is, if the operation is to access a register, the register can only be read and not written to. If the operation has both read and write (e.g. non-destructive and destructive) modes, then the operation is only permitted in a non-destructive mode. If the operation has only a single mode of operation then it is simply allowed or not in dependence on whether the instruction is on the benign list.

In other examples, the benign list merely provides a permitted/not-permitted state and there is no differentiation of operations that may be read only. Also in this example, the effective execution level becomes EL0. In practice, this could be set to any other level by changing step 914 to the relevant level. The above implementation also assumes that the EL0 bit can be set for any execution level. That is, even if the E0 bit is set and the execution level is EL3, then the permissions will be lowered to being approximately those of E0. In practice, however, a further step could be added (e.g. between steps 914 and 918) so that if the execution level is above a particular level, then the E0 bit has no effect. That is, if the current execution level is above EL1 then the operation will be accepted, otherwise the flow proceeds to step 918. In situations where the E0 bit can affect all execution levels, it is necessary to have some mechanism for the E0 bit to be set/unset. This could be done in hardware based on the program counter value/call stack as previously described. Alternatively, it could be hard coded so that certain execution levels (e.g. EL3) always have read/write access to the E0 bit.

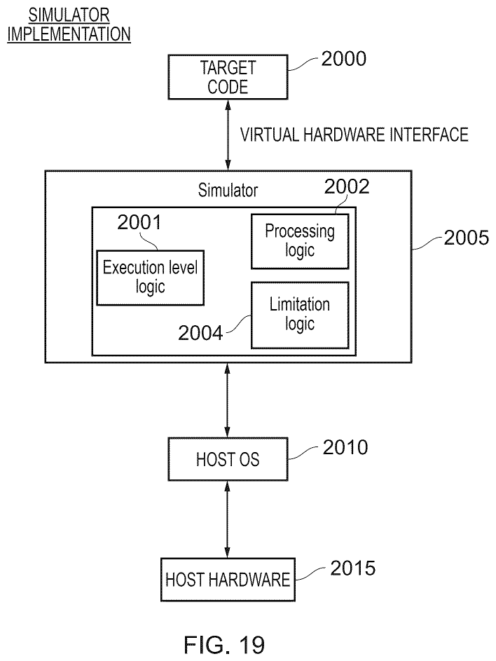

FIG. 19 schematically illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 2015, optionally running a host operating system 2010, supporting the simulator program 2005. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 2015), some simulated embodiments may make use of the host hardware, where suitable.

The simulator program 2005 may be stored on a computer-readable storage medium (which may be a non-transitory medium), and provides a program interface (instruction execution environment) to the target code 2000 (which may include applications, operating systems and a hypervisor) which is the same as the interface of the hardware architecture being modelled by the simulator program 2005. Thus, the program instructions of the target code 2000 may be executed from within the instruction execution environment using the simulator program 2005, so that a host computer 2015 which does not actually have the hardware features of the apparatuses discussed above can emulate these features, these being provided by execution level logic 2001, processing logic 2002, and limitation logic 2004.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various configurations within the scope of the present disclosure are set out in the following numbered clauses.
Clause 1. Apparatus comprising:
   an access control register configured to store a configuration value;
   processing circuitry configured to execute instructions;
   execution level circuitry configured to apply execution controls of an active execution level for a functionality; and
   limitation circuitry configured to apply one or more execution controls of a less privileged execution level than the active execution level for the functionality, without affecting the active execution level, in response to the configuration value being a particular value.
Clause 2. The apparatus according to Clause 1, wherein
   the limitation circuitry is configured to apply the execution limits of the less privileged execution level for a plurality of functionalities.
Clause 3. The apparatus according to any preceding Clause, comprising:
   a plurality of registers, wherein
   the functionality comprises accessing the registers; and
   the execution level circuitry is configured to apply the execution controls of the active execution level for the functionality by controlling the set of the registers that can be accessed by the instructions; and
   the limitation circuitry is configured to apply the one or more execution controls of the less privileged execution level for the functionality by further controlling the set of registers to which the active execution level can access, without affecting the active execution level.
Clause 4. The apparatus according to Clause 3, wherein the limitation circuitry is configured to apply the one or more execution controls of the less privileged execution level in response to the configuration value being the particular value when the active execution level has a given execution level.
Clause 5. The apparatus according to clause 4, wherein the given execution level is a kernel execution level.
Clause 6. The apparatus according to Clause 5, wherein the limitation circuitry is configured to further control the set of the registers by excluding at least some of the registers that require the active execution level to be at least the kernel execution level to access.
Clause 7. The apparatus according to Clause 5, wherein the limitation circuitry is configured to further control the set of the registers by excluding only some of the registers that require the active execution level to be at least the kernel execution level to access.
Clause 8. The apparatus according to any one of Clauses 5-7, wherein the limitation circuitry is configured to further control the set of registers by setting the set of registers to initially being what is accessible when the active execution level is a user space execution level.
Clause 9. The apparatus according to Clause 8, wherein the limitation circuitry is configured to additionally allow access to one or more benign registers that are inaccessible when the active execution level is a user space execution level.
Clause 10. The apparatus according to Clause 8 wherein the limitation circuitry is configured to allow read-only access to one or more benign registers that are inaccessible when the active execution level is a user space execution level.
Clause 11. The apparatus according to any preceding Clause, wherein the functionality comprises executing the instructions; and the execution level circuitry is configured to apply the execution controls of the active execution level for the functionality by reducing a set of the instructions that are permitted to be executed to only a subset of the instructions that are permitted to be executed by the active execution level.
Clause 12. The apparatus according to Clause 11, wherein the subset of instructions corresponds with instructions that are permitted to be accessed by a user-space execution level.
Clause 13. The apparatus according to Clause 11, wherein the set of instructions includes and the subset of instructions excludes one or more system management instructions.
Clause 14. The apparatus according to any preceding Clause, comprising: limitation control circuitry configured to set the configuration value to the particular value and to unset the configuration value from the particular value.
Clause 15. The apparatus according to Clause 14 wherein the limitation control circuitry is configured to set the configuration value to the particular value and to unset the configuration value from the particular value in dependence on a current program counter value.
Clause 16. The apparatus according to any one of Clauses 14-15, wherein the limitation control circuitry is configured to set the configuration value to the particular value and to unset the configuration value from the particular value in dependence on at least part of a current call stack.
Clause 17. The apparatus according to Clause 15, wherein the limitation control circuitry is configured to unset the configuration value from the particular value in response to a return instruction being executed.
Clause 18. The apparatus according to Clause 17, wherein the return instruction is an exception return instruction.
Clause 19. The apparatus according to any preceding Clause, wherein the limitation circuitry configured to further limit execution of the instructions by causing an exception to be taken.
Clause 20. The apparatus according to any preceding Clause, wherein data access permissions in relation to a main memory are unaffected by restrictions of the limitation circuitry.
Clause 21. A data processing method comprising:
   storing a configuration value;
   executing instructions;
   applying execution controls of an active execution level for a functionality; and
   applying one or more execution controls of a less privileged execution level than the active execution level for the functionality, without affecting the active execution level, in response to the configuration value being a particular value.
Clause 22. A computer program for controlling a host data processing apparatus to provide an instruction execution environment, the computer program comprising:
   an access control data structure configured to store a configuration value;
   processing program logic configured to execute instructions;
   execution level program logic configured to limit execution apply execution controls of an active execution level for a functionality; and
   limitation program logic configured to apply one or more execution controls of a less privileged execution level than the active execution level for the functionality, without affecting the active execution level, in response to the configuration value being a particular value.
Clause 23. A computer-readable storage medium to store the computer program of Clause 22.

In brief overall summary an apparatus is provided that includes an access control register that stores a configuration value and processing circuitry executes instructions. Execution level circuitry limits execution of the instructions based on an active execution level from a plurality of execution levels. Limitation circuitry further limits execution of the instructions without affecting the active execution level, in response to the configuration value being a particular value.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. Apparatus comprising:
an access control register configured to store a configuration value;
processing circuitry configured to execute instructions;
execution level circuitry configured to apply execution controls of an active execution level for a functionality; and
limitation circuitry configured to apply one or more execution controls of a less privileged execution level than the active execution level for the functionality, without affecting the active execution level, in response to the configuration value being a particular value.

2. The apparatus according to claim 1, wherein
the limitation circuitry is configured to apply the one or more execution controls of the less privileged execution level for a plurality of functionalities.

3. The apparatus according to claim 1, comprising:
a plurality of registers, wherein
the functionality comprises accessing the registers; and
the execution level circuitry is configured to apply the execution controls of the active execution level for the functionality by controlling the set of the registers that can be accessed by the instructions; and
the limitation circuitry is configured to apply the one or more execution controls of the less privileged execution level for the functionality by further controlling the set of registers to which the active execution level can access, without affecting the active execution level.

4. The apparatus according to claim 3, wherein
the limitation circuitry is configured to apply the one or more execution controls of the less privileged execution level in response to the configuration value being the particular value when the active execution level has a given execution level.

5. The apparatus according to claim 4, wherein
the given execution level is a kernel execution level.

6. The apparatus according to claim 5, wherein
the limitation circuitry is configured to apply the one or more execution controls of the less privileged execution level by excluding at least some of the registers that require the active execution level to be at least the kernel execution level to access.

7. The apparatus according to claim 5, wherein
the limitation circuitry is configured to apply the one or more execution controls of the less privileged execution level by excluding only some of the registers that require the active execution level to be at least the kernel execution level to access.

8. The apparatus according to claim 5, wherein
the limitation circuitry is configured to apply the one or more execution controls of the less privileged execution level by setting the set of registers to initially being what is accessible when the active execution level is a user space execution level.

9. The apparatus according to claim 6, wherein
the limitation circuitry is configured to additionally allow access to one or more benign registers that are inaccessible when the active execution level is a user space execution level.

10. The apparatus according to claim 6 wherein
the limitation circuitry is configured to allow read-only access to one or more benign registers that are inaccessible when the active execution level is a user space execution level.

11. The apparatus according to claim 1, wherein
the functionality comprises executing the instructions; and
the execution level circuitry is configured to apply the execution controls of the active execution level for the functionality by reducing a set of the instructions that are permitted to be executed to only a subset of the instructions that are permitted to be executed by the active execution level.

12. The apparatus according to claim 11, wherein
the subset of instructions corresponds with instructions that are permitted to be accessed by a user-space execution level.

13. The apparatus according to claim 11, wherein
the set of instructions includes and the subset of instructions excludes one or more system management instructions.

14. The apparatus according to claim 1, comprising:
limitation control circuitry configured to set the configuration value to the particular value and to unset the configuration value from the particular value.

15. The apparatus according to claim 14 wherein
the limitation control circuitry is configured to set the configuration value to the particular value and to unset the configuration value from the particular value in dependence on a current program counter value.

16. The apparatus according to claim 14, wherein
the limitation control circuitry is configured to set the configuration value to the particular value and to unset the configuration value from the particular value in dependence on at least part of a current call stack.

17. The apparatus according to claim 15, wherein
the limitation control circuitry is configured to unset the configuration value from the particular value in response to a return instruction being executed.

18. The apparatus according to claim 1, wherein
the limitation circuitry configured to apply the one or more execution controls of the less privileged level execution level by causing an exception to be taken.

19. The apparatus according to claim 1, wherein
data access permissions in relation to a main memory are unaffected by restrictions of the limitation circuitry.

20. A method comprising:
storing a configuration value;
executing instructions;
applying execution controls of an active execution level for a functionality; and
applying one or more execution controls of a less privileged execution level than the active execution level for the functionality, without affecting the active execution level, in response to the configuration value being a particular value.

21. A computer program for controlling a host data processing apparatus to provide an instruction execution environment, the computer program comprising:
an access control data structure configured to store a configuration value;
processing program logic configured to execute instructions;
execution level program logic configured to apply execution controls of an active execution level for a functionality; and
limitation program logic configured to apply one or more execution controls of a less privileged execution level than the active execution level for the functionality, without affecting the active execution level, in response to the configuration value being a particular value.

22. A computer-readable storage medium to store the computer program of claim 21.
